(19) United States
(12) Patent Application Publication
(10) Pub. No.: US 2022/0132082 A1
(43) Pub. Date: Apr. 28, 2022

(54) DISPLAY SYSTEM, HEAD-UP DISPLAY, AND MOVING VEHICLE

(71) Applicant: Panasonic Intellectual Property Management Co., Ltd., Osaka (JP)

(72) Inventors: Kouzou YUUKI, Osaka (JP); Yutaka KUMANO, Hyogo (JP); Yuji FUWA, Osaka (JP)

(73) Assignee: Panasonic Intellectual Property Management Co., Ltd., Osaka (JP)

(21) Appl. No.: 17/572,373

(22) Filed: Jan. 10, 2022

Related U.S. Application Data
(63) Continuation of application No. PCT/JP2020/020387, filed on May 22, 2020.

(30) Foreign Application Priority Data
Jul. 11, 2019 (JP) 2019-129666

(51) Int. Cl. H04N 9/31; G02F 1/1333; G02B 27/01; B60K 37/02

(52) U.S. Cl. CPC H04N 9/3144; G02F 1/133385; B60K 2370/1529; B60K 37/02; G02B 27/0101

(57) ABSTRACT

A display system includes a display and a light-transmitting member. The light-transmitting member has light-transmitting properties and is disposed to face a display screen of the display to dissipate heat generated by the display to outside of the display. The light-transmitting member has a higher thermal conductivity than quartz.

### CROSS-REFERENCE TO RELATED APPLICATIONS

The present application is a Bypass Continuation of International Application No. PCT/JP2020/020387 filed on May 22, 2020, which is based upon, and claims the benefit of priority to, Japanese Patent Application No. 2019-129666, filed on Jul. 11, 2019. The entire contents of both applications are incorporated herein by reference.

### TECHNICAL FIELD

The present disclosure relates to a display system, a head-up display, and a moving vehicle.

### BACKGROUND ART

Head-up display devices have been developed recently as devices to be installed in moving vehicles such as automobiles. As such a head-up display device, a device including a liquid crystal display (LCD) panel that transmits light emitted from a light source has been known in the art. For example, the liquid crystal display device disclosed in JP 2016-31457 A includes an LCD panel 3000, a transparent member 2000, and a heat sink 1000 as shown in FIG. 8. The transparent member 2000 is bonded to a lower surface (first surface) of the LCD panel 3000 and the heat sink 1000 is bonded to another surface, opposite from the surface bonded to the LCD panel 3000, of the transparent member 2000 as shown in FIG. 8.

According to JP 2016-31457 A, the heat generated in a central portion of the LCD panel 3000 through transmission of the light emitted from a light source is transferred through the transparent member 2000 into the heat sink 1000, thereby reducing overheat in the central portion of the LCD panel 3000.

The liquid crystal display device of JP 2016-31457 A is configured to dispose the transparent member 2000 on the first surface of the LCD panel 3000 to dissipate the heat generated in the central portion of the LCD panel 3000. Thus, if the temperature rises on the other surface, opposite from the first surface, of the LCD panel 3000, then the heat cannot be dissipated sufficiently in some cases.

### SUMMARY

The present disclosure provides a display system, a head-up display, and a moving vehicle, all of which are configured to reduce an increase in temperature on a display screen of a display.

A display system according to an aspect of the present disclosure includes a display and a light-transmitting member. The display has a display screen to let light emerge from the display. The light-transmitting member has light-transmitting properties and is disposed to face the display screen of the display to dissipate heat generated by the display to outside of the display. The light-transmitting member has a higher thermal conductivity than quartz.

A head-up display according to another aspect of the present disclosure includes the display system described above and a projection optical system to project, onto a windshield, display light emerging from the display system.

A moving vehicle according to still another aspect of the present disclosure includes the head-up display described above and a moving vehicle body to be equipped with the head-up display.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 illustrates an automobile equipped with a head-up display including a display system according to an exemplary embodiment;

FIG. 2 illustrates a user's view in a situation where the head-up display is used;

FIG. 3 illustrates the structure of the head-up display;

FIG. 4 is a schematic cross-sectional view of the display system;

FIG. 5 is a schematic perspective view of the display system;

FIG. 6 is a schematic cross-sectional view of a display system according to a variation;

FIG. 7 is a schematic perspective view of the display system; and

FIG. 8 is an exploded perspective view of a display system of a known head-up display.

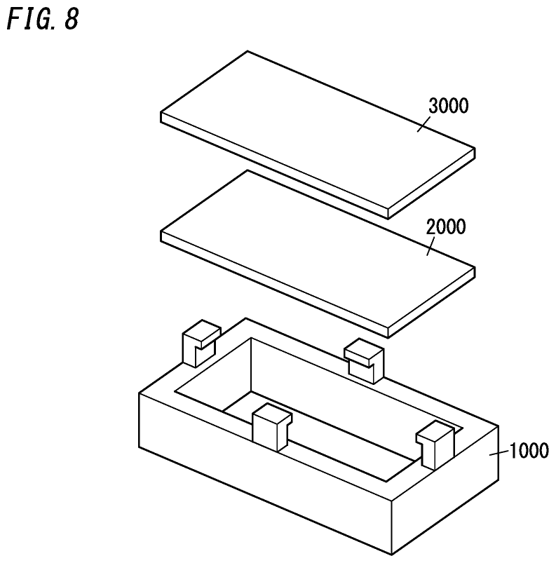

### DETAILED DESCRIPTION

### Embodiment

An embodiment of the present disclosure will now be described with reference to the accompanying drawings.

### Configuration of Automobile Using Head-Up Display

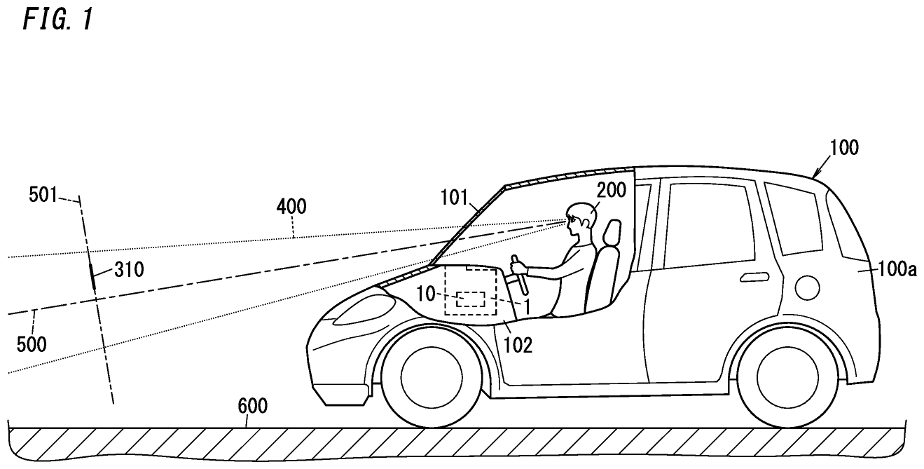

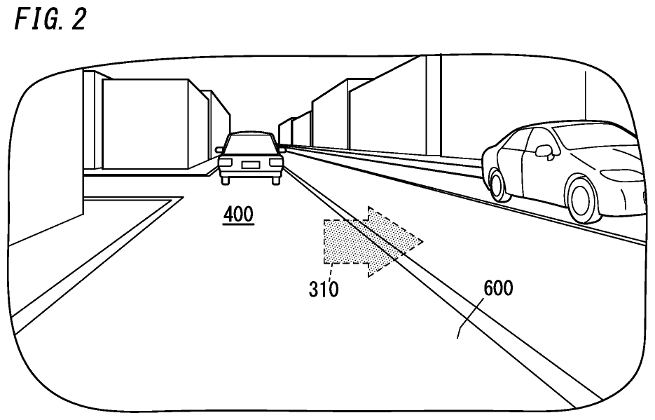

First, an automobile 100 that uses a head-up display 1 including a display system 10 will be described with reference to FIGS. 1 and 2. The head-up display 1 may be installed in, for example, a moving vehicle. In the following description, an exemplary embodiment in which the moving vehicle is an automobile 100 as shown in FIG. 1 will be described as an example. The automobile 100 includes a vehicle body 100a serving as a moving vehicle body and the head-up display 1 to be installed in the vehicle body 100a. FIG. 1 illustrates the automobile 100 equipped with the head-up display 1 including the display system 10.

This head-up display 1 is installed in the vehicle cabin of the automobile 100 so as to project an image onto the windshield 101 of the vehicle body 100a of the automobile 100 from under the windshield 101. The head-up display 1 is placed in a dashboard 102 under the windshield 101. When an image is projected onto the windshield 101 from the head-up display 1, the user 200, who may be a driver, recognizes the image reflected from the windshield 101 serving as a reflector.

In other words, the user 200 recognizes, through the windshield 101, a virtual image 310 that has been projected onto a target space 400 that is set in front of the automobile 100. As used herein, the “virtual image” refers to an image formed, as if an object were actually present, on the user's 200 eyes by a reflected light beam, when the light beam emerging from the head-up display is reflected from a reflector such as the windshield to turn into the reflected light beam. This allows the user 200 who is driving the automobile 100 to view the virtual image 310 projected by the head-up display 1 such that the virtual image 310 is superimposed on his or her view of the real space in front of the automobile 100 as shown in FIG. 2. FIG. 2 illustrates the user's view in a situation where the head-up display 1 is used.

Thus, the head-up display 1 allows the user 200 to be presented as the virtual image 310 with, and visually recognize, various types of driver assistance information including vehicle velocity information, navigation information, pedestrian information, foregoing vehicle information, lane deviation information, and vehicle condition information. In the example illustrated in FIG. 2, the virtual image 310 represents a piece of navigation information, which is shown as an arrow indicating a lane change, for example. This allows the user 200 to visually acquire the driver assistance information just by shifting his or her gaze only slightly in the state where he or she is watching the real space in front of the windshield 101.

The head-up display 1 forms the virtual image 310 to be projected onto the target space 400 on a virtual plane 501 which intersects with the optical axis 500 of the head-up display 1. In this embodiment, the optical axis 500 extends, in the target space 400 in front of the automobile 100, along a road surface 600 in front of the automobile 100. The virtual plane 501 on which the virtual image 310 is formed is substantially perpendicular to the road surface 600. For example, if the road surface 600 is a horizontal plane, the virtual image 310 is displayed on a vertical plane. Alternatively, the virtual plane 501 on which the virtual image 310 is formed may be tilted with respect to the optical axis 500. The tilt angle defined by the virtual plane 501 with respect to the optical axis 500 is not limited to any particular angle.

### Configuration of Head-Up Display

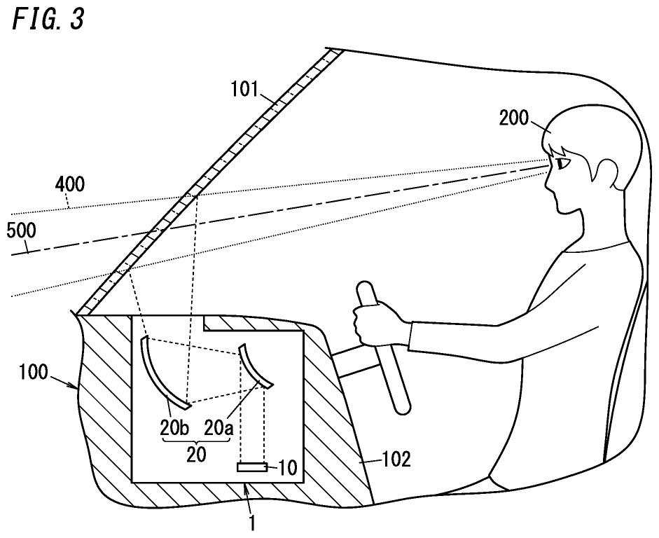

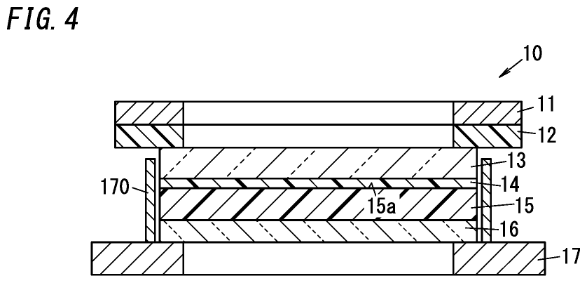

Next, the configuration of the head-up display 1 will be described with reference to FIG. 3. As shown in FIG. 3, the head-up display 1 includes the display system 10 and a projection optical system 20. The display system 10 and the projection optical system 20 will be described in detail with reference to FIGS. 3 and 4.

### Configuration of Projection Optical System

The projection optical system 20 is configured to reflect, toward the windshield 101, light representing an image which has emerged from the display system 10 and thereby project the image onto the windshield 101 and eventually project the virtual image 310 onto the target space 400. As shown in FIG. 3, the projection optical system 20 includes a first optical member 20a and a second optical member 20b. The first optical member 20a is a mirror that reflects the light coming from the display system 10 toward the second optical member 20b. The second optical member 20b is a mirror that reflects the light coming from the first optical member 20a toward the windshield 101. In this manner, the projection optical system 20 projects the virtual image 310 onto the target space 400 by having the light representing an image which has emerged from the display system 10 projected by the first optical member 20a and the second optical member 20b toward the windshield 101.

### Configuration of Display System

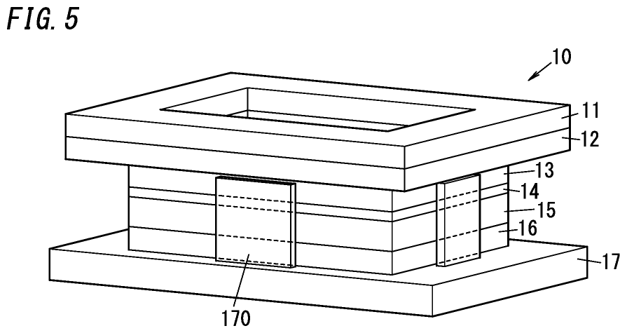

Next, the configuration of the display system 10 will be described. As shown in FIGS. 4 and 5, the display system 10 includes a display 15, a light-transmitting member 13, a light-diffusing member 16, a pressing member 11, and a frame member 17. These constituent members of the display system 10 will be described one by one.

The display 15 has a display screen 15a. Specifically, the display 15 may be implemented as an LCD panel or an organic electroluminescent (OEL) panel, for example. Particularly when the display 15 is implemented as an LCD panel, the display 15 produces an image on the display screen 15a by selectively transmitting the light that has come from a backlight. The display 15 has a rectangular outer peripheral shape and is a flat plate member. In particular, the display 15 has the display screen 15a as a surface on which an image is displayed. The display screen 15a is a region corresponding to a light-transmitting portion through which light is selectively transmitted.

The light-transmitting member 13 has light-transmitting properties and has a higher thermal conductivity than quartz. The light-transmitting member 13 is suitably bonded onto the display screen 15a of the display 15 via a bonding member 14 as shown in FIG. 4. The bonding member 14 has light-transmitting properties. The bonding member 14 may be, for example, an adhesive, an adhesive tape, or resin. If the bonding member 14 is an adhesive, for example, then the light-transmitting member 13 is bonded onto the display screen 15a with the adhesive. As used herein, the “thermal conductivity” refers to a thermal conductivity value measured when the environment in which the light-transmitting member 13 is placed has an ambient temperature of 20° C.

In this case, even though the light-transmitting member 13 and the display 15 may be directly bonded together without the bonding member 14, interposing the bonding member 14 between the light-transmitting member 13 and the display 15 contributes to improving the image quality. Specifically, interposing the bonding member 14 may reduce the chances of leaving the gap between the display screen 15a of the display 15 and the light-transmitting member 13, reduce the refraction, reflection, and diffusion, for example, of light between the display screen 15a and the light-transmitting member 13, and eventually reduce the distortion of the image. Consequently, interposing the bonding member 14 would improve the image quality, compared to directly bonding the light-transmitting member 13 and the display 15 together with no bonding member 14 interposed between themselves.

The light-transmitting member 13 has the function of improving the heat dissipation capability of the display system 10. In particular, the light-transmitting member 13 may reduce an increase in the temperature of the display 15. The light-transmitting member 13 has a higher thermal conductivity than quartz. The light-transmitting member 13 may be made of, for example, sapphire glass. The light-transmitting member 13, as well as the display 15, is a flat plate member and has a rectangular outer peripheral shape. In this embodiment, the light-transmitting member 13 is of the same size as the display 15. However, the light-transmitting member 13 does not have to be of the same size as the display 15. Alternatively, the size of the light-transmitting member 13 may be reduced as long as the heat dissipation capability of the light-transmitting member 13 is not imparted. Conversely, the size of the light-transmitting member 13 may be increased as long as the light-transmitting member 13 does not interfere with any other member of the display system 10.

The pressing member 11 is a member for pressing the light-transmitting member 13 toward the display screen 15a. The pressing member 11 is a rectangular plate member and has a rectangular opening positioned to face the display area of the display 15. That is to say, the pressing member 11 is a frame-shaped member with a rectangular outer peripheral shape. The pressing member 11 is in contact with a portion, not facing the display area of the display 15, of the light-transmitting member 13. The pressing member 11 is disposed opposite from the display 15 with respect to the light-transmitting member 13. The pressing member 11 comes into contact with the light-transmitting member 13 from the other side, opposite from the display 15, thereby pressing the light-transmitting member 13 against the display 15. In addition, the pressing member 11 has thermal conductivity. The thermal conductivity of the pressing member 11 is suitably higher than that of the light-transmitting member 13. The pressing member 11 may be made of aluminum, for example.

Optionally, the pressing member 11 may press the light-transmitting member 13 via a buffer member 12. In that case, the buffer member 12 is arranged between the pressing member 11 and the light-transmitting member 13. The buffer member 12 has elasticity. The buffer member 12, as well as the pressing member 11, is a plate member and has a rectangular outer peripheral shape and a rectangular opening. That is to say, the buffer member 12 is a frame-shaped member with a rectangular outer peripheral shape. The thermal conductivity of the buffer member 12 is suitably higher than that of the light-transmitting member 13.

The light-diffusing member 16 is provided opposite from the display screen 15a of the display 15 as shown in FIG. 4. The light-diffusing member 16 has the function of increasing the degree of uniformity of the display screen 15a of the display 15. The light-diffusing member 16 has a rectangular outer peripheral shape and is a plate member. The light-diffusing member 16 has light-transmitting properties. Examples of materials for the light-diffusing member 16 include polyethylene terephthalate (PET) and glass. The light-diffusing member 16 suitably has no thermal insulation properties. In addition, the light-diffusing member 16 is suitably large enough to cover a light-transmitting portion of the display 15.

The frame member 17 is provided to mount the display 15 thereon. The frame member 17 is disposed in contact with a peripheral edge portion of a surface, opposite from the display 15, of the light-diffusing member 16. In addition, the frame member 17 suitably has a higher thermal conductivity than the light-transmitting member 13 and the light-diffusing member 16. The frame member 17 may be made of aluminum, for example. Providing the frame member 17 with such a configuration facilitates improving the heat dissipation capability of the display system 10. Note that if the pressing member 11 is able to dissipate the heat of the display 15 sufficiently, then the frame member 17 may be made of a resin, for example. The frame member 17 has a rectangular outer peripheral shape and is a cylindrical member with a plurality of (e.g., four in this embodiment) holders 170. These holders 170 fix the light-transmitting member 13, the display 15, and the light-diffusing member 16 with respect to the frame member 17 as shown in FIG. 5. More specifically, the four holders 170 are arranged, if the light-transmitting member 13, the bonding member 14, the display 15, and the light-diffusing member 16 are regarded as a single rectangular parallelepiped member, to respectively face the four side surfaces of the rectangular parallelepiped member. In addition, this rectangular parallelepiped member is fixed by the four holders 170 with respect to the frame member 17.

In the display system 10, the light-transmitting member 13, the display 15, and the light-diffusing member 16 are held by the plurality of holders 170 of the frame member 17 as described above. In addition, the pressing member 11 is in contact with the light-transmitting member 13 either directly or via the buffer member 12. That is to say, the heat generated on the display screen 15a of the display 15 is transferred through the light-transmitting member 13 to the pressing member 11 and dissipated into the outside air.

The light-transmitting member 13 is preferably made of sapphire glass. In this case, sapphire glass has a refractive index of about 1.75 with respect to light having a wavelength of 1.06 μm. Making the light-transmitting member 13 of such a material with a refractive index of about 1.75 may increase the difference in refractive index between the display 15 and the light-transmitting member 13 so much as to affect the image quality in some cases.

In those cases, the effect on the image quality may be reduced by using an appropriate bonding member 14. That is to say, the bonding member 14 is suitably used such that respective refractive indices f1, f2, and f3 of the display 15, the light-transmitting member 13, and the bonding member 14 satisfy the following conditional expression (1):

f1<f3 <f2 (1).

### Recapitulation

In the display system 10 described above, the light-transmitting member 13 is bonded to the display screen 15a of the display 15 via the bonding member 14, thus contributing to improving the heat dissipation capability of the display screen 15a. In this case, if the light-transmitting member 13 is provided for the other surface, opposite from the display screen 15a, of the display 15, for example, then the heat generated on the display screen 15a of the display 15 by the sunlight condensed on the display screen 15a of the display 15 cannot be dissipated sufficiently in some cases. Particularly, as the size of the head-up display 1 increases, the effect of the sunlight further increases. In addition, the more localized the sunlight condensed on the display screen 15a of the display 15 is, the more likely the temperature on the display screen 15a of the display 15 rises instantaneously enough to adversely affect the display operation by the display 15. In contrast, the display system 10 according to this embodiment reduces, even if the sunlight is condensed on the display screen 15a of the display 15, the chances of causing an increase in the temperature of the display 15, thus reducing harmful effects on the display operation by the display 15.

In addition, bonding the display screen 15a of the display 15 and the light-transmitting member 13 together with the bonding member 14 that satisfies the conditional expression (1) when the light-transmitting member 13 is made of a material with a high refractive index such as sapphire glass may reduce the chances of affecting the display operation due to the difference in refractive index.

### Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Next, variations of the exemplary embodiment will be enumerated one after another. In the following description of variations, any constituent element thereof, having the same function as a counterpart of the embodiment described above, will be designated by the same reference numeral as that counterpart's, and description thereof will be omitted herein.

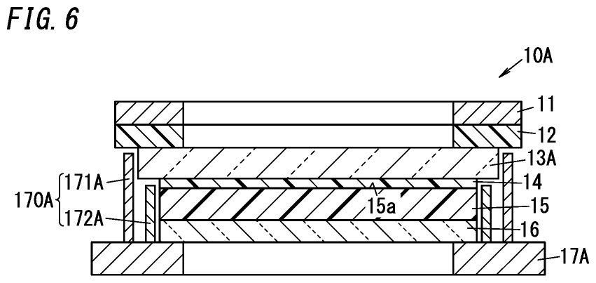

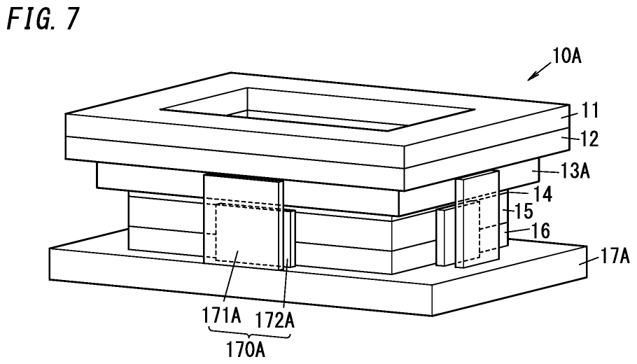

FIGS. 6 and 7 illustrate a display system 10A according to a variation. The display system 10A includes the display 15, a light-transmitting member 13A, the light-diffusing member 16, the pressing member 11, and a frame member 17A. In this display system 10A, the surface, facing the display screen 15a of the display 15, of the light-transmitting member 13A has a larger area than the display screen 15a of the display 15, unlike the display system 10. More specifically, the light-transmitting member 13A has a larger area than the display screen 15a such that the display screen 15a is included inside the light-transmitting member 13A when viewed from the surface facing the display screen 15a.

In the display system 10A, the light-transmitting member 13A, the display 15, and the light-transmitting member 16 are held by a plurality of (e.g., four in this embodiment) holders 170A of the frame member 17A. Each holder 170A includes a first holding portion 171A and a second holding portion 172A. In this variation, the light-transmitting member 13A is held by the first holding portions 171A, while the display 15 and the light-diffusing member 16 are held by the second holding portions 172A. More specifically, the four first holding portions 171A are arranged to respectively face the four side surfaces of the light-transmitting member 13A and fix the light-transmitting member 13A with respect to the frame member 17A. In addition, the four second holding portions 172A are arranged, if the bonding member 14, the display 15, and the light-diffusing member 16 are regarded as a single rectangular parallelepiped member, to respectively face the four side surfaces of the rectangular parallelepiped member. In addition, this rectangular parallelepiped member is fixed by the four second holding portions 172A with respect to the frame member 17A.

This display system 10A includes the light-transmitting member 13A, of which a surface facing the display screen 15a of the display 15 has a larger area than the display screen 15a, thus contributing to increasing the area of contact between the light-transmitting member 13A and the pressing member 11. This contributes to improving the heat dissipation capability.

### Other Variations

For example, the display system 10 (10A) may include no pressing member 11 or buffer member 12. Alternatively, the display system 10 (10A) may include the buffer member 12 with no pressing member 11. In that case, the light-transmitting member 13 (13A) is suitably configured to be bonded to a member with a heat dissipation capability either directly or via the buffer member 12. In addition, the display system 10 (10A) may include no light-diffusing member 16, for example.

### Subjunction

As is clear from the foregoing description of an exemplary embodiment and its variations, the present disclosure has the following aspects. In the following description, reference signs are inserted in parentheses just for the sake of clarifying correspondence in constituent elements between the following aspects of the present disclosure and the exemplary embodiment described above.

A display system (10, 10A) according to a first aspect includes a display (15) and a light-transmitting member (13, 13A). The display (15) has a display screen (15a) to let light emerge from the display screen. The light-transmitting member (13, 13A) has light-transmitting properties and is disposed to face the display screen (15a) of the display (15) to dissipate heat generated by the display (15) to outside of the display (15). The light-transmitting member (13, 13A) has a higher thermal conductivity than quartz. The first aspect reduces the chances of causing an increase in the temperature of the display (15).

A display system (10, 10A) according to a second aspect may be implemented in conjunction with the first aspect. In the second aspect, the display system (10, 10A) further includes a bonding member (14) arranged between the display (15) and the light-transmitting member (13, 13A). The bonding member (14) bonds the display screen (15a) and the light-transmitting member (13, 13A) together. The second aspect allows the light-transmitting member (13, 13A) to be easily fixed onto the display (15), reduces the chances of causing a decline in image quality, and may also avoid deteriorating the display definition in a most effective case.

A display system (10, 10A) according to a third aspect may be implemented in conjunction with the second aspect. In the third aspect, respective refractive indices f1, f2, and f3 of the display (15), the light-transmitting member (13, 13A), and the bonding member (14) of the display system (10, 10A) satisfy the following conditional expression (1):

f1<f3<f2 (1).

The third aspect reduces the chances of causing a decline in image quality and may also avoid deteriorating the display definition in a most effective case.

A display system (10, 10A) according to a fourth aspect may be implemented in conjunction with any one of the first to third aspects. In the fourth aspect, the display system (10, 10A) further includes a pressing member (11) made of a material having a heat dissipation capability and pressing the light-transmitting member (13, 13A) toward the display screen (15a). The fourth aspect reduces the chances of causing an increase in the temperature of the display (15).

A display system (10, 10A) according to a fifth aspect may be implemented in conjunction with the fourth aspect. In the fifth aspect, the display system (10, 10A) further includes a buffer member (12) arranged between the light-transmitting member (13, 13A) and the pressing member (11). The fifth aspect allows the pressing member (11) to press the light-transmitting member (13, 13A) toward the display screen (15a) with more reliability.

A display system (10, 10A) according to a sixth aspect may be implemented in conjunction with any one of the first to fifth aspects. In the sixth aspect, the display system (10, 10A) further includes a light-diffusing member (16) disposed opposite from the light-transmitting member (13, 13A) with respect to the display (15). The light-diffusing member (16) diffuses light transmitting through the light-diffusing member. The sixth aspect facilitates increasing the degree of uniformity on the display screen (15a) of the display (15).

A display system (10, 10A) according to a seventh aspect may be implemented in conjunction with any one of the first to sixth aspects. In the seventh aspect, the display has an opposite surface opposite from the display screen, and the display system (10, 10A) further includes a frame member (17, 17A) made of a material having a heat dissipation capability and disposed to dissipate heat, transferred from the display (15) through the opposite surface, to outside of the display (15). The seventh aspect reduces the chances of causing an increase in the temperature of the display (15).

A display system (10, 10A) according to an eighth aspect may be implemented in conjunction with the seventh aspect. In the eighth aspect, the frame member (17, 17A) includes a holder (170, 170A). The holder (170, 170A) holds the light-transmitting member (13, 13A) and the display (15) to fix the light-transmitting member (13, 13A) and the display (15) with respect to the frame member (17, 17A). The eighth aspect allows the light-transmitting member (13, 13A) and the display (15) to be easily fixed with respect to the frame member (17, 17A).

A display system (10A) according to a ninth aspect may be implemented in conjunction with the eighth aspect. In the ninth aspect, a surface, facing the display screen (15a), of the light-transmitting member (13A) has a larger area than the display screen (15a). The ninth aspect reduces the chances of causing an increase in the temperature of the display (15).

A display system (10A) according to a tenth aspect may be implemented in conjunction with the ninth aspect. In the tenth aspect, the holder (170A) includes a first holding portion (171A) and a second holding portion (172A). The first holding portion (171A) holds the light-transmitting member (13A). The second holding portion (172A) holds the display (15). The tenth allows the light-transmitting member (13A) and the display (15) to be easily fixed to the frame member (17A).

A display system (10, 10A) according to an eleventh aspect may be implemented in conjunction with any one of the first to tenth aspects. In the eleventh aspect, the light-transmitting member (13, 13A) is made of sapphire glass. The eleventh aspect reduces the chances of causing an increase in the temperature of the display (15).

A head-up display (1) according to a twelfth aspect includes the display system (10, 10A) according to any one of the first to eleventh aspects and a projection optical system (20) to project, onto a windshield (101), display light emerging from the display system (10, 10A). The twelfth aspect reduces the chances of causing an increase in the temperature of the display (15).

A moving vehicle (100) according to a thirteenth aspect includes the head-up display (1) of the twelfth aspect and a moving vehicle body (100a) to be equipped with the head-up display (1). The thirteenth aspect reduces the chances of causing an increase in the temperature of the display (15).

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A display system comprising:
a display having a display screen configured to let light emerge from the display screen; and
a light-transmitting member having light-transmitting properties,
the light-transmitting member being disposed to face the display screen of the display to dissipate heat generated by the display to outside of the display,
the light-transmitting member having a higher thermal conductivity than quartz.

2. The display system of claim 1, further comprising a bonding member arranged between the display and the light-transmitting member and bonding the display screen and the light-transmitting member together.

3. The display system of claim 2, wherein
respective refractive indices f1, f2, and f3 of the display, the light-transmitting member, and the bonding member satisfy the following conditional expression (1):
f1<f3<f2 (1).

4. The display system of claim 1, further comprising a pressing member made of a material having a heat dissipation capability and pressing the light-transmitting member toward the display screen.

5. The display system of claim 4, further comprising a buffer member arranged between the light-transmitting member and the pressing member.

6. The display system of claim 1, further comprising a light-diffusing member disposed opposite from the light-transmitting member with respect to the display and configured to diffuse light transmitting through the light-diffusing member.

7. The display system of claim 1, wherein
the display has an opposite surface opposite from the display screen, and
the display system further comprises a frame member made of a material having a heat dissipation capability and disposed to dissipate heat, transferred from the display through the opposite surface, to outside of the display.

8. The display system of claim 7, wherein
the frame member includes a holder to hold the light-transmitting member and the display to fix the light-transmitting member and the display with respect to the frame member.

9. The display system of claim 8, wherein
a surface, facing the display screen, of the light-transmitting member has a larger area than the display screen.

10. The display system of claim 9, wherein
the holder includes:
a first holding portion to hold the light-transmitting member; and
a second holding portion to hold the display.

11. The display system of claim 1, wherein
the light-transmitting member is made of sapphire glass.

12. The display system of claim 4, wherein
the pressing member has an opening positioned to face the display area of the display.

13. The display system of claim 4, wherein
the pressing member is disposed opposite from the display with respect to the light-transmitting member and the pressing member comes into contact with the light-transmitting member from a side, opposite from the display, thereby pressing the light-transmitting member toward the display.

14. The display system of claim 5, wherein
the buffer member has an opening positioned to face the display area of the display.

15. The display system of claim 7, wherein
the frame member is disposed in contact with a peripheral edge portion of a surface, opposite from the display, of the light-diffusing member.

16. The display system of claim 8, wherein
the holder is one of a plurality of holders arranged around the light-transmitting member and the display.

17. A head-up display comprising:
the display system of claim 1; and
a projection optical system configured to project, onto a windshield, display light emerging from the display system.

18. A moving vehicle comprising:
the head-up display of claim 17; and
a moving vehicle body to be equipped with the head-up display.
